(19) United States
(12) Patent Application Publication
(10) Pub. No.: US 2004/0183765 A1
(43) Pub. Date: Sep. 23, 2004

(54) Information processing apparatus and display brightness control method

(75) Inventor: Toshikazu Morisawa, Tokorozawa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/766,479

(22) Filed: Jan. 29, 2004

(30) Foreign Application Priority Data
Jan. 31, 2003 (JP) 2003-024421

(51) Int. Cl. G09G 3/36

(52) U.S. Cl. 345/89

(57) ABSTRACT

An information processing apparatus has a display device which can control display brightness, a unit for controlling the display brightness of the display device according to a peripheral environment, a unit for inputting an operation input, and a unit for switching brightness control of the display device by the unit for controlling display brightness to brightness control by another unit for controlling display brightness, and, when inputting a predetermined operating instruction, the unit for switching brightness control of the display device to another brightness control temporarily switches the brightness control of the display device from brightness control by the unit for controlling display brightness to brightness control in accordance with the predetermined operating instruction.

### CROSS-REFERENCE TO RELATED APPLICATIONS

This application is based upon and claims the benefit of priority from the prior Japanese Patent Application No. 2003-024421, filed Jan. 31, 2003, the entire contents of which are incorporated herein by reference.

### BACKGROUND OF THE INVENTION

1. Field of the Present Invention

The present invention relates to an information processing apparatus having a display device whose display brightness is controllable and a display brightness control method.

2. Description of the Related Art

In an information processing apparatus having a display device (for example, an LCD) which can control display brightness, the following device is known (for example, see Jpn. Pat. Appln. KOKAI Publication No. 10-228010). The device has a automatic brightness adjustment mechanism for automatically adjusting a backlight of the LCD to optimal brightness according to a peripheral luminance. In addition, in a device which does not have the above automatic brightness adjustment mechanism, a device having a manual brightness adjustment mechanism for adjusting the backlight of the above-described LCD by specific key operation is known.

Of the above-described information processing apparatus, in the device having the automatic brightness adjustment mechanism, the display brightness is automatically adjusted according to a peripheral brightness while in normal use, and thus, the usability during normal use is good. However, there has been a problem that, when an attempt is made to significantly change the display brightness according to information to be displayed, a use mode, and the like, only fine adjustment can be made at most, and desired display brightness cannot be set simply and easily. Further, in the device having the automatic brightness adjustment mechanism, when an attempt is made to significantly change the display brightness according to information to be displayed, a use mode and the like, desired display brightness can be set simply and easily by key operation. However, while in normal use, there has been a problem that the usability during normal use is poor because the display brightness must be adjusted according to a peripheral brightness every time.

As described above, in the conventional information processing apparatus having the display device whose display brightness is controllable, there has been a problem on the aspect of usability in each brightness adjustment mechanism.

### BRIEF SUMMARY OF THE INVENTION

An information processing apparatus according to an aspect of the present invention is characterized by comprising: a display device which can control display brightness; means for controlling the display brightness of the display device according to a peripheral environment; means for inputting an operation input; and means for switching brightness control of the display device by the means for controlling display brightness to brightness control by another means for controlling display brightness, in which, when inputting a predetermined operating instruction, the means for switching brightness control of the display device to another brightness control temporarily switches the brightness control of the display device from brightness control by the means for controlling display brightness to brightness control in accordance with the predetermined operating instruction.

### BRIEF DESCRIPTION OF THE SEVERAL VIEWS OF THE DRAWING

The accompanying drawings, which are incorporated in and constitute a part of the specification, illustrate presently preferred embodiments of the present invention, and together with the general description given above and the detailed description of the preferred embodiments given below, serve to explain the principles of the present invention.

FIG. 1 is a block diagram depicting a configuration of an information processing apparatus according to first and second embodiments of the present invention;

FIG. 2 is a block diagram depicting essential portions according to the first and second embodiments of the present invention;

FIG. 3 is an external view showing an example of a configuration of the information processing apparatus according to the first embodiment of the present invention and showing an example of key arrangement for controlling brightness;

FIG. 4 is a flow chart showing a processing procedure in the first embodiment of the present invention;

FIG. 5 is a flow chart showing a processing procedure in the first embodiment of the present invention;

FIG. 6 is a flow chart showing a processing procedure in the first embodiment of the present invention;

FIG. 7 is a view showing an example of a configuration of a brightness management table according to the second embodiment of the present invention;

FIG. 8 is a flow chart showing a processing procedure in the second embodiment of the present invention; and

FIG. 9 is a flow chart showing a processing procedure in the second embodiment of the present invention.

### DETAILED DESCRIPTION OF THE INVENTION

Hereinafter, preferred embodiments of the present invention will be described with reference to the accompanying drawings.

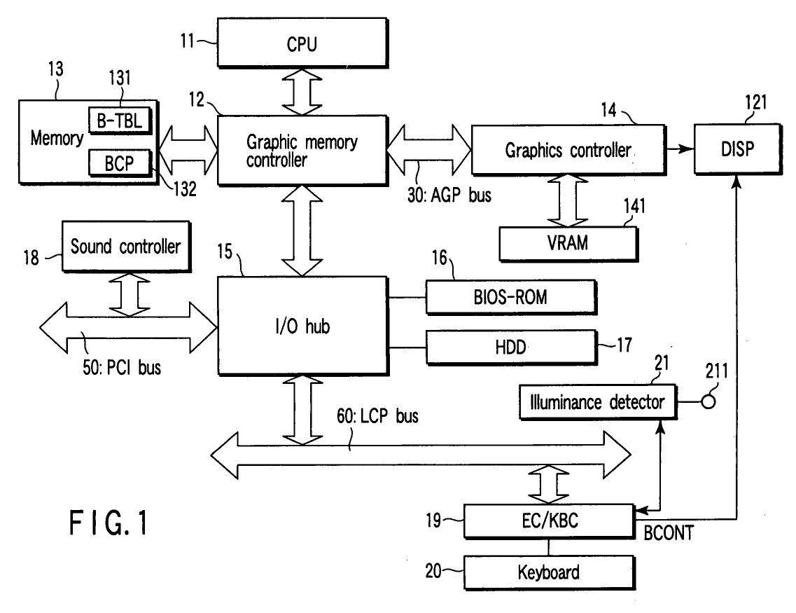

A first embodiment of the present invention will be described with reference to FIGS. 1 to 6. In the first embodiment, with a predetermined key input operation on a keyboard 20, a function capable of temporary manual brightness control by key operation is achieved by switching brightness control of a display device 121 to brightness control with manual adjustment in accordance with an operation input instruction of the keyboard 20 from brightness control by automatic adjustment.

FIG. 1 shows a configuration of an information processing apparatus according to an embodiment of the present invention. Here, by way of example of a notebook type portable personal computer which is drivable with the battery, a configuration of such a computer system is shown.

This computer system, as shown in FIG. 1 has a CPU 11, a graphic memory controller hub 12, a memory (main memory) 13, a graphics controller 14, a VRAM 141, an I/O hub 15, a BIOS-ROM 16, a hard disk drive (HDD) 17, a sound controller 18, a keyboard embedded controller (EC/KB) 19, a keyboard 20, an illuminance detector 21, a display device (DISP) 121 and the like. Further, the memory 13 stores a brightness control program (BCP) 131 and a variety of programs including a brightness management table (T-TBL) 132.

The graphics controller 14 controls display of the display device 121 under the control of an operating system (OS) executed by the CPU 11. The graphics controller 14 controls display of an external display device, which is connected via a connection interface of a variety of external displays such as a CRT terminal, a DVI terminal, or a TV terminal (not shown).

The illuminance detector 21 has an illuminance sensor 211, detects luminance in use environment, i.e., the illuminance at the periphery of equipment, and sends detection data to the keyboard embedded controller 19.

The keyboard embedded controller 19 acquires illuminance detection data from the illuminance detector 21 under the control of the brightness control program (BCP) 131 executed by the CPU 11, and sends the acquired illuminance detection data to the CPU 11. The keyboard embedded controller 19 sets the automatic brightness adjustment data received from the CPU 11 at a brightness controller of the display device 121.

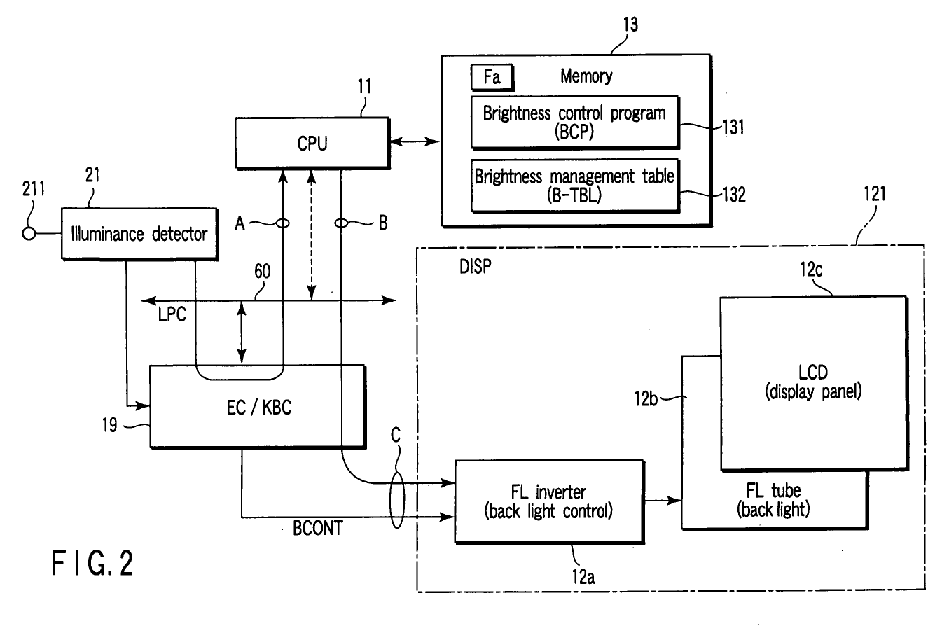

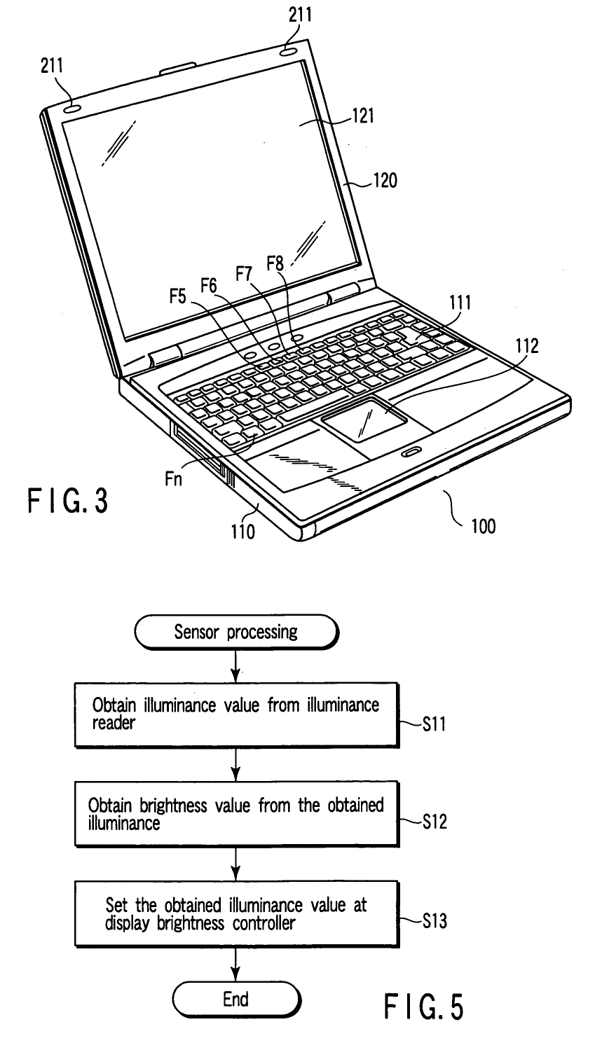

The keyboard embedded controller (EC) 19 sets manual brightness adjustment data (BCONT) according to key operation at the brightness controller of the display device 121 when the key operation for controlling the display brightness of the display brightness of the display device 121 has been made on the keyboard 20 under the control of the brightness control program (BCP) 131 executed by the CPU 11. A specific example of keys for controlling the display brightness will be described later with reference to FIG. 3. The brightness controller of the display device 121 will be described later with reference to FIG. 2.

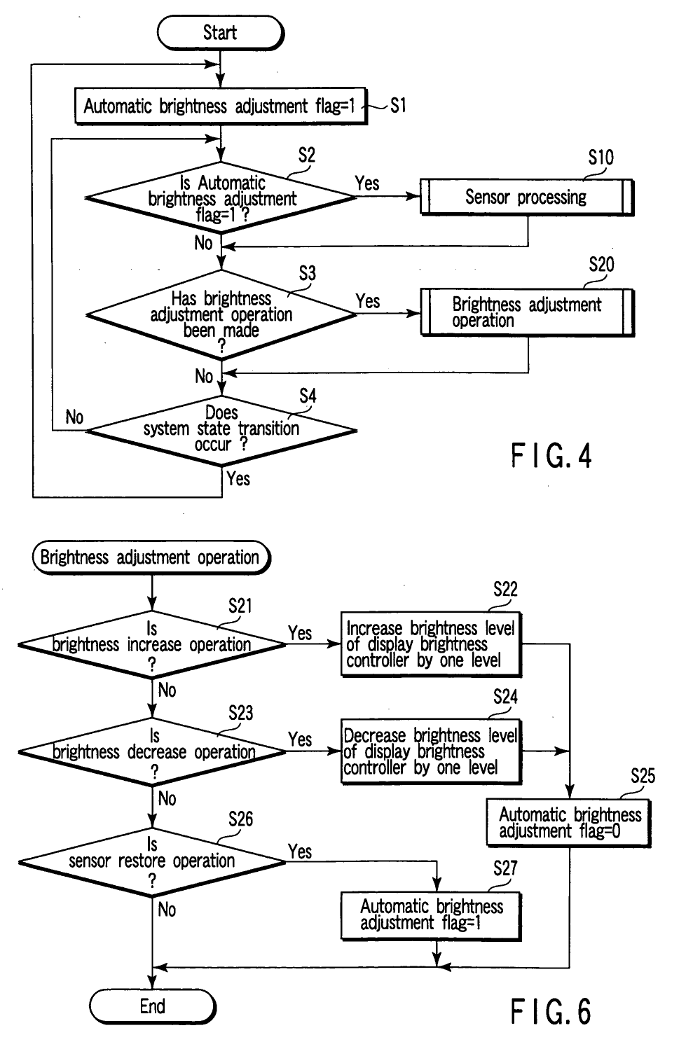

The CPU 11 controls an operation of the computer. The CPU 11 executes a variety of processing functions in accordance with an operating system and an application program or a utility program, etc. loaded from the hard disk drive 17 on the main memory 13. In the first embodiment, the CPU 11 executes processing for adjusting brightness shown in FIGS. 4 to 6 in accordance with the brightness control program (BCP) 131. In addition, the CPU 11 receives an instruction command according to key operation of the keyboard 20 from the keyboard embedded controller (EC/KBC) 19, and executes processing in accordance with the instruction command.

FIG. 2 shows a configuration of essential portions of the computer system in the first embodiment.

The display device 121, as shown in FIG. 2, has an LCD (Liquid Control Display) 12c used as a display panel, an FL tube 12b used as a backlight of the display panel, and a brightness controller 12a having an FL inverter for controlling the illuminance of the backlight.

The CPU 11 executes brightness adjustment processing in accordance with the brightness control program (BCP 131) stored in the memory 13. The processing procedures are shown in the flow charts of FIGS. 4 to 6 described later. In brightness adjustment processing, the CPU 11 sets automatic brightness adjustment data (B) or manual brightness adjustment data (BCONT) as brightness setting data (C) at the brightness controller 12a in accordance with a value of a automatic brightness adjustment flag (Fa) set in a flag resistor concerning display control provided in the memory 13. Here, when a value of the automatic brightness adjustment flag (Fa) is set to “1”, the CPU 11 sets the automatic brightness adjustment data (B) at the brightness controller 12a. When the automatic brightness adjustment flag (Fa) is set to “0”, the CPU 11 sets the manual brightness adjustment data (BCONT) at the brightness controller 12a. When the value of the automatic brightness adjustment flag (Fa) is set to “1”, the CPU 11 acquires illuminance detection data (A) from the illuminance detector 21 via the keyboard embedded controller 19. Then, the CPU 11 determines a brightness value optimal to a current use environment based on the acquired data and the set value, and sets the automatic brightness adjustment data (B) having the brightness value as the brightness setting data (C) to the brightness controller 12a.

FIG. 3 shows an external configuration of the information processing apparatus and an example of a key setting location to control brightness in the above-described embodiment. Here, the above external configuration exemplifies an external configuration of a notebook type personal computer. A computer 100 according to the embodiment of the present invention shown in FIG. 3 has a computer main body 110 and a display unit (display unit cabinet) 120. In the display unit 120, a display device using an LCD is incorporated as a display device 121. The display unit 120 having the display device 121 incorporated therein is turnably mounted on the computer main body 110 between an open position and a closed position.

The computer main body 110 has a thin-box-shaped cabinet. The computer main body 110 has a keyboard 20 on its cabinet top face, and an armrest on a top face of the cabinet portion of the keyboard 20. The computer main body 110 has a touch panel 112 at a substantial center part of the armrest.

The display unit (display unit cabinet) 120 has illuminance sensors 211, 211 for sensing the peripheral luminance (light intensity) on the front face of the cabinet. The illuminance detector 21 sends an illuminance sense signal sensed by the illuminance sensors 211, 211 as illuminance detection data to the keyboard embedded controller 19.

The keyboard 20 has operation keys for manually adjusting the display brightness of the display device 121. In the first embodiment, a description will be given assuming that an instruction for manual brightness adjustment is supplied by combined key operation of keys “Fn” and “F5”; a brightness down operation is made by a key “F6”; a brightness up operation is made by a key “F7”; and instruction for returning to automatic brightness adjustment is supplied by a key “F8”.

FIGS. 4 to 6 show a processing procedures in the first embodiment of the present invention. This processing is achieved by the CPU 11 executing processing of the brightness control program (BCP) 131. Here, processing for automatic brightness adjustment shown in FIG. 5 is executed by “sensor processing” shown in the step S10 of FIG. 4. Processing for manual brightness adjustment shown in FIG. 6 is executed by “brightness adjustment operation” shown in the step S20.

Now, an operation in the first embodiment of the present invention will be described with reference to FIGS. 1 to 6.

At system startup, the automatic brightness adjustment flag (Fa) is set to a default value (“1”) (step S1 of FIG. 4). The CPU 11 executes brightness adjustment processing in accordance with a brightness control program (BCP) 131 stored on the memory 13 in display control processing of the display device 121.

In brightness adjustment processing, the CPU 11 first reads a value of the automatic brightness adjustment flag (Fa) set in a display control flag register in the memory 13. Based on the read value, the CPU 11 determines whether or not the automatic brightness adjustment flag (Fa) is currently valid (step S2 of FIG. 4).

Here, the CPU 11 determines that automatic brightness adjustment is valid if the value of the above automatic brightness adjustment flag (Fa) is set to “1”, and carries out processing for automatic brightness adjustment (sensor processing) (step S10 of FIG. 4). In automatic brightness adjustment processing, the CPU 11 acquires illuminance detection data (A) from the illuminance detector 21 (step S11 of FIG. 5), and compares the acquired illuminance detection data (A) with a set value to decide a brightness value optimal to a current use environment (step S12 of FIG. 5). Then, the CPU 11 sets the automatic brightness adjustment data (B) having the brightness value as the brightness setting data (C) to the brightness controller 12a (step S13 of FIG. 5). The brightness controller 12a controls turn-on of the FL tube 12b so that the illuminance becomes equal to the backlight illuminance in accordance with the brightness value of brightness setting data.

As described above, in normal use, the display brightness of the display device 121 is adjusted to the optimal display brightness according to the peripheral luminance. When the state is in automatic brightness adjustment, if manual brightness adjustment is instructed by key operation of the keyboard 20 (for example, combination of the key operation of the key “Fn” and the key “F5”) (step S3 of FIG. 4), display brightness adjustment processing of the display device 121 is switched from processing for automatic brightness adjustment to processing for manual brightness adjustment. In this manner, instead of processing for automatic brightness adjustment, a function for manual brightness adjustment by key operation on the keyboard 20 becomes valid (step S20 of FIG. 4).

In manual brightness adjustment processing, the CPU 11 sets manual brightness adjustment data (BCONT) according to key operation of the keyboard 20 as the brightness setting data (C) at the brightness controller 12a, instead of the automatic brightness adjustment data (B). At this time, when a instruction key for increasing brightness (for example, a key “F7”) or a instruction key for decreasing brightness (for example, a key “F6”) on the keyboard 20 is operated (steps S21 and S23 of FIG. 6), the CPU 11 sets the automatic brightness adjustment flag (Fa) to “0” which enables a function for manual brightness adjustment (step S25 of FIG. 6). When the instruction key for increasing brightness on the keyboard 20 is operated one time (step S21 of FIG. 6), the CPU 11 increases the brightness by one level (step S22 of FIG. 6). When the instruction key for increasing brightness is operated one time (step S23 of FIG. 6), the CPU 11 decrease the brightness by one level (step S24 of FIG. 6).

By simple key operation as described above, the display device 121 can be set easily and speedily at desired display brightness. Thus, for example, in a case or the like in which the brightness of a use place suddenly changes during mobile computing, the display brightness of the display device 121 can be always adjusted to the optimal brightness.

When a function for manual brightness adjustment is terminated, a recovery instruction key for automatic brightness adjustment on the keyboard 20 (for example, a key “F8”) is operated (step S26 of FIG. 6).

By the key operation, the automatic brightness adjustment flag (Fa) is returned to “1” (step S27 of FIG. 6), processing for automatic brightness adjustment as described above functions validly again.

In this way, in the first embodiment, when predetermined key input has been received from the keyboard 20, the CPU 11 can temporarily set the display brightness of the display device 121 to desired optimal brightness easily and speedily as required by temporarily switching the brightness control of the display device 121 from the brightness control by automatic brightness adjustment to the brightness control by manual brightness adjustment in accordance with an operation input instruction of the keyboard 20. For example, by applying to mobile computing or the like, operability and visibility can be significantly improved.

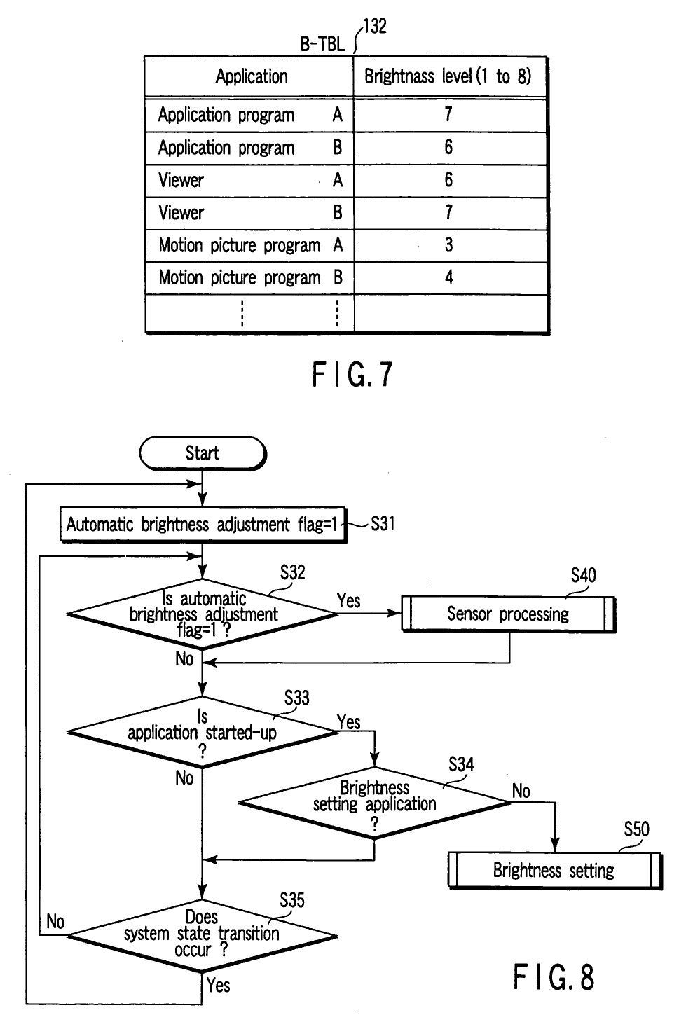

A second embodiment of the present invention will be described with reference to equipment configurations shown in FIGS. 1 and 2 and with reference to FIGS. 7 to 9. In the second embodiment, when start-up of a predetermined application program has been sensed, by switching the brightness control of a display device 121 from the brightness control by automatic brightness adjustment to setting brightness control specific to the above mentioned predetermined application program, it is possible to set optimal display brightness for individual application programs. Further, the functions of the second embodiment are provided together with those of the first embodiment, thereby improving functionality more significantly.

As shown in FIGS. 1 and 2, a memory 13 has a brightness management table (B-TBL) 132. In the brightness management table (B-TBL) 132, as shown in FIG. 7, a brightness level is set with respect to each of arbitrary application programs using the display device 121. In this manner, when the set application program has been initiated, the CPU 11 carries out application display processing based on the settings of the brightness management table (B-TBL) 132.

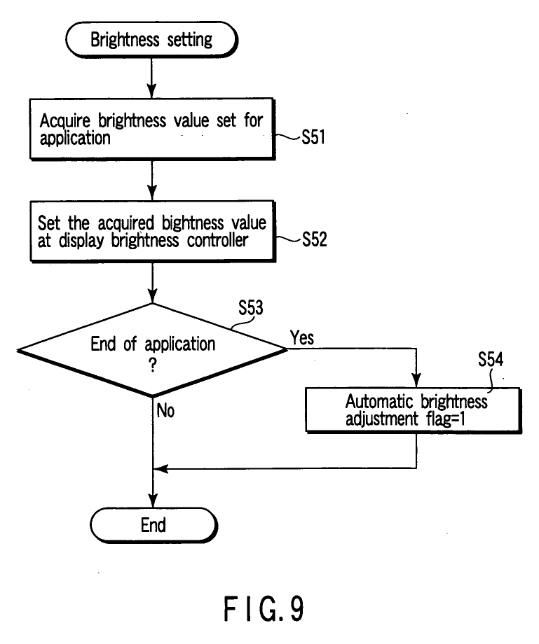

FIG. 8 shows a processing procedure according to the second embodiment of the present invention. FIG. 9 shows a “brightness setting” processing procedure shown in FIG. 8. The processing according to the second embodiment is achieved by executing processing of the CPU 11 or brightness control program (BCP) 131 in the same manner as in the first embodiment. The “sensor processing” processing procedure for shown in FIG. 8 is identical to that shown in FIG. 5 of the first embodiment. A duplicate description of such processing is omitted here.

An operation in the second embodiment of the present invention will be described with reference to the above described figures.

At system startup, the CPU 11 sets the automatic brightness adjustment flag (Fa) to a default value (“1”) (step S31 of FIG. 8). The CPU 11 executes brightness adjustment processing in accordance with the brightness control program (BCP) 131 stored on the memory 13 in the display control processing of the display device 121.

In brightness adjustment processing, the CPU 11 reads a value of the automatic brightness adjustment flag (Fa) included in a display control flag register in the memory 13. Based on the read value, the CPU 11 determines whether or not automatic brightness adjustment is currently valid (step S32 of FIG. 8).

Here, if the value of the above-described automatic brightness adjustment flag (Fa) is set to “1”, the CPU 11 determines that automatic brightness adjustment is valid, and carries out the automatic brightness adjustment processing (step S40 of FIG. 8). In automatic brightness adjustment processing, the CPU 11 acquires illuminance detection data (A) from the illuminance detector 21, and then compares the acquired illuminance detection data (A) with the set value to decide a brightness value optimal to a current use environment. Then, the CPU 11 sets the automatic brightness adjustment data (B) having the brightness value as the brightness setting data (C) at the brightness controller 12a. The brightness controller 12a controls a turn-on of the FL tube 12b so that the illuminance becomes equal to the backlight illuminance in accordance with a brightness value of the brightness setting data.

As described above, while in normal use, the display brightness of the display device 121 is adjusted to optimal display brightness according to the peripheral luminance.

When a state is in automatic brightness adjustment, if a predetermined application program is started-up (step S33 of FIG. 8), the CPU 11 checks whether or not the predetermined application program is an application program set in the brightness management table (B-TBL) 132 by referring to the brightness management table (B-TBL) 132 (step S34 of FIG. 8). If the above predetermined application program is the application program set in the brightness management table (B-TBL) 132 (YES in the step S34 of FIG. 8), the brightness setting processing is carried out in accordance with the settings of the brightness management table (B-TBL) 132 (step S50) in FIG. 8).

In this brightness setting processing, the CPU 11 acquires a brightness level set to the started-up application by referring to the brightness management table (B-TBL) 132 (step S51 of FIG. 9). Then, the CPU 11 sets the brightness setting data (C) having the value of the brightness level at the brightness controller 12a (step S52 of FIG. 9).

In this manner, the display device 121 displays an image display of the application program with the display brightness optimal to the started-up application program.

When the application program is terminated (YES in the step S53 of FIG. 9), the automatic brightness adjustment flag (Fa) returns to “1” (step S54 of FIG. 9), and automatic brightness adjustment processing functions validly again.

In this way, when start-up of the predetermined application program has been sensed, since the brightness control of the display device 121 is switched from the brightness control by automatic brightness adjustment to brightness control specific to the application program, images can be displayed with the display brightness optimal to each of a variety of application programs.

According to the second embodiment, a function for optimizing the display brightness on an application program by program basis has been provided. In addition, it is possible to set the display brightness for each of arbitrary images in the application program. In this case, the brightness level in accordance with a program instruction is achieved by setting the brightness setting data (C) at the brightness controller 12a as in the above embodiments. By providing such a display brightness control function, since the optimal display brightness can be specified by program setting on an arbitrary image by image basis in an arbitrary scene in the individual application programs, a presentation effect or the like can be enhanced.

According to the embodiments of the present invention, there can be provided an information processing apparatus having a usable brightness adjustment mechanism with excellent operability and functionality, the mechanism being capable of temporarily switching the display brightness from the auto adjusting brightness to auto adjusting brightness or desired optimal brightness along the display content as required.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An information processing apparatus comprising:
a display device which can control display brightness;
means for controlling the display brightness of the display device according to a peripheral environment;
means for inputting an operation input; and
means for switching brightness control of the display device by the means for controlling display brightness to brightness control by another means for controlling display brightness,
wherein, when inputting a predetermined operating instruction, the means for switching brightness control of the display device to another brightness control temporarily switches the brightness control of the display device from brightness control by the means for controlling display brightness to brightness control in accordance with the predetermined operating instruction.

2. The information apparatus according to claim 1, wherein the means for switching brightness control of the display device to another brightness control includes means for sensing start-up of a preset application program, and switches brightness control of the display device from brightness control by the means for controlling the display brightness to brightness control specific to the application program when the sensing means senses start-up of the application program.

3. The information apparatus according to claim 1, wherein the means for switching brightness control of the display device to another brightness control includes means for inputting the predetermined operating instruction, switching brightness control of the display device from brightness control by the means for controlling the display brightness to brightness control in accordance with the predetermined operating instruction, and, returning brightness control of the display device to brightness control by the means for controlling the display brightness when inputting the predetermined operating instruction.

4. The information apparatus according to claim 1, wherein the means for switching brightness control of the display device to another brightness control includes means for inputting the predetermined operating instruction, switching brightness control of the display device from brightness control by the means for controlling the display brightness to brightness control in accordance with the predetermined operating instruction, and, returning brightness control of the display device to brightness control by the means for controlling the display brightness when inputting a predetermined specific operating input.

5. The information apparatus according to claim 1, wherein the means for switching brightness control of the display device to another brightness control includes means for inputting the predetermined operating instruction, switching brightness control of the display device from brightness control by the means for controlling the display brightness to brightness control in accordance with the predetermined operating instruction, and, returning brightness control of the display device to brightness control by the means for controlling the display brightness after a predetermined period of time has elapsed.

6. The information apparatus according to claim 1, wherein the means for switching brightness control of the display device to another brightness control includes means for switching brightness control of the display device from brightness control by the means for controlling the display brightness to brightness control in accordance with an instruction of the keyboard, and, returning brightness control of the display device to brightness control by the means for controlling the display brightness when a predetermined state transition according to system operation has occurred.

7. The information apparatus according to claim 2, wherein the means for switching brightness control of the display device to another brightness control includes holding means for holding brightness information set to the application program; and means for, when initiation of the application program has been sensed, switching brightness control of the display device from brightness control by the means for controlling the display brightness to brightness control in accordance with the brightness information held by the holding means.

8. The information apparatus according to claim 2, wherein the means for switching brightness control of the display device includes information acquiring means for acquiring brightness information from the application program; and means for, when the information acquiring means acquires brightness information from the application program, switching brightness control of the display device from brightness control by the means for controlling the display brightness to brightness control in accordance with the brightness information acquired by the information acquiring means.

9. The information apparatus according to claim 2, wherein the means for switching brightness control of the display device to another brightness control includes means for sensing an end of the application program and means for, when the sensing means senses an end of the application program, returning brightness control of the display device to brightness control by the means for controlling the display brightness.

10. The information apparatus according to claim 2, wherein the means for switching brightness control of the display device to another brightness control includes means for returning brightness control of the display device to brightness control by the means for controlling the display brightness in accordance with an instruction of the application program.

11. A display brightness control method for the information processing apparatus including a keyboard and a display device which can control display brightness, comprising
temporarily switching brightness control of the display device to brightness control in accordance with the operation input of the keyboard, when a predetermined key of the keyboard is operated, in controlling display brightness of the display device according to a peripheral environment.

12. A display brightness control method for an information processing apparatus including a display device which can control display brightness, comprising
switching brightness control of the display device to a predetermined brightness control to the application program, when a predetermined application program is started-up, in controlling display brightness of the display device according to a peripheral environment.

13. A display brightness control method for an information processing apparatus comprising a display device which can control display brightness, comprising
switching brightness control of the display device to brightness control in accordance with an instruction of the application program, when a predetermined application program is initiated, in controlling display brightness of the display device according to a peripheral environment.
